(19) United States
(12) Patent Application Publication
(10) Pub. No.: US 2012/0116932 A1
(43) Pub. Date: May 10, 2012

(54) EVALUATING REQUESTS USING HISTORICAL BENCHMARKING

(75) Inventors: Joshua David Blake, Charlotte, NC (US); Kiala L. Davis, Indian Trail, NC (US); Kristen Taylor Keniry, Charlotte, NC (US); Kathleen Jones MacLaren, Charlotte, NC (US)

(73) Assignee: Bank of America Corporation, Charlotte, NC (US)

(21) Appl. No.: 12/941,826

(22) Filed: Nov. 8, 2010

(51) Int. Cl. G06Q 10/00

(52) U.S. Cl. 705/30

(57) ABSTRACT

A system for evaluating an invoice for work includes a processing device configured for determining one or more billing data parameters comprising a threshold payment amount based on information associated with the invoice or the work, retrieving from a historical billing database, historical billing data corresponding to the one or more determined billing data parameters, comparing the retrieved historical billing data including the threshold payment amount with at least a portion of the information extracted from the invoice including billing information extracted from the invoice, and determining whether to approve the invoice based on the comparison, wherein determining whether to approve the invoice is dependent upon the comparison of the threshold payment amount with the requested payment amount corresponding to billing information extracted from the invoice.

### FIELD

In general, embodiments of the invention relate to systems for facility management. More specifically, embodiments of the invention relate to systems for evaluating requests using historical benchmarking, the requests being, for example, made through and invoice from a vendor, for payment for work performed in response to a work order issued by a facility management enterprise.

### BACKGROUND

Generally, requests for payment via invoice are considered on a case-by-case basis subjectively. The invoices are typically submitted, either prior to, or upon completion of work, previously contracted between a vendor and a facility management enterprise. Typically, the vendor has been contracted by the facility management enterprise to perform a type of work for a particular price. In other arrangements, the enterprise keeps a list of approved vendors that corresponds with specific types of work. In one example, an enterprise requests a bid or preliminary invoice from a vendor for a work project. In some instances, the enterprise has set a somewhat arbitrary threshold. However, information regarding market rates for services to be performed or that have been performed may be beneficial in setting a threshold and making evaluation of invoices. Therefore, a system for using historical benchmarking of similar work in the same or similar geographic area to establish a threshold and thereafter apply the threshold to vendors submitting invoices is needed.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention address the above needs and/or achieve other advantages by providing systems, methods and computer program products for evaluating requests, such as requests for payment via invoice, using historical benchmarking. In some embodiments, a system for evaluating an invoice for work includes a processing device configured for determining one or more billing data parameters comprising a threshold payment amount based on information associated with the invoice or the work, retrieving from a historical billing database, historical billing data corresponding to the one or more determined billing data parameters, comparing the retrieved historical billing data including the threshold payment amount with at least a portion of the information extracted from the invoice including billing information extracted from the invoice, and determining whether to approve the invoice based on the comparison, wherein determining whether to approve the invoice is dependent upon the comparison of the threshold payment amount with the requested payment amount corresponding to billing information extracted from the invoice.

According to embodiments of the invention a method for evaluating an invoice for work includes determining one or more billing data parameters based on information associated with the invoice or the work; retrieving from a historical billing database, historical billing data corresponding to the one or more determined billing data parameters; comparing, using a processing device, the retrieved historical billing data with at least a portion of the information extracted from the invoice; and determining whether to approve the invoice based on the comparison. In some embodiments, determining one or more billing data parameters comprises determining a geographical parameter based on geographic information corresponding to the geographic region wherein the work is to be or has been performed. In some such embodiments, comparing comprises comparing retrieved historical billing data associated with the geographic region wherein the work is to be or has been performed with billing information extracted from the invoice.

In some embodiments, determining one or more billing data parameters comprises determining a threshold payment amount; and comparing the retrieved historical billing data with at least a portion of the information extracted from the invoice comprises comparing the threshold payment amount with a requested payment amount corresponding to billing information extracted from the invoice. In some such embodiments, determining whether to approve the invoice is dependent upon the comparison of the threshold payment amount with the requested payment amount corresponding to billing information extracted from the invoice. In some such embodiments, determining whether to approve the invoice comprises determining to approve the invoice when the billing information extracted from the invoice indicates a requested payment amount less than or equal to the threshold payment amount. In other such embodiments, determining whether to approve the invoice comprises determining not to approve the invoice if the billing information extracted from the invoice indicates a requested payment amount greater than the threshold payment amount.

In some embodiments, determining one or more parameters comprises determining a geographic parameter based on geographic information corresponding to the geographic region wherein the work is to be or has been performed; determining a type of work parameter based on the type of work associated with the invoice; and determining a historical payment amount based on the determined geographic parameter and the type of work parameter, such that the historical payment amount relates to the historical payment required within the geographic region corresponding to the geographic information for the type of work associated with the invoice. In some such embodiments, determining one or more billing data parameters comprises determining a threshold payment amount equal to the historical payment amount and wherein comparing comprises comparing the threshold payment amount with a requested payment amount corresponding to billing information extracted from the invoice. In other such embodiments, the historical payment amount is an average of a plurality of payment amounts within the geographic region for the type of work. In yet other such embodiments, the historical payment amount is a median of a plurality of payment amount within the geographic region for the type of work.

In some embodiments, the method also includes initiating escalation for additional consideration of the invoice if the invoice is not approved.

In some embodiments, comparing comprises comparing retrieved historical billing data associated with a similar geographic region to the geographic region wherein the work is to be or has been performed with billing information extracted from the invoice.

According to embodiments of the invention, a system for evaluating an invoice for work includes a processing device configured for determining one or more billing data parameters based on information associated with the invoice or the work; retrieving from a historical billing database, historical billing data corresponding to the one or more determined billing data parameters; comparing the retrieved historical billing data with at least a portion of the information extracted from the invoice; and determining whether to approve the invoice based on the comparison. In some such embodiments, determining one or more billing data parameters comprises determining a geographical parameter based on geographic information corresponding to the geographic region wherein the work is to be or has been performed. In some such embodiments, comparing comprises comparing retrieved historical billing data associated with the geographic region wherein the work is to be or has been performed with billing information extracted from the invoice.

In some embodiments, determining one or more billing data parameters comprises determining a threshold payment amount; and comparing the retrieved historical billing data with at least a portion of the information extracted from the invoice comprises comparing the threshold payment amount with a requested payment amount corresponding to billing information extracted from the invoice. In some such embodiments, determining whether to approve the invoice is dependent upon the comparison of the threshold payment amount with the requested payment amount corresponding to billing information extracted from the invoice. In some such embodiments, determining whether to approve the invoice comprises determining to approve the invoice when the billing information extracted from the invoice indicates a requested payment amount less than or equal to the threshold payment amount. In other such embodiments, determining whether to approve the invoice comprises determining not to approve the invoice if the billing information extracted from the invoice indicates a requested payment amount greater than the threshold payment amount.

In some embodiments, determining one or more parameters comprises determining a geographic parameter based on geographic information corresponding to the geographic region wherein the work is to be or has been performed; determining a type of work parameter based on the type of work associated with the invoice; and determining a historical payment amount based on the determined geographic parameter and the type of work parameter, such that the historical payment amount relates to the historical payment required within the geographic region corresponding to the geographic information for the type of work associated with the invoice. In some such embodiments, determining one or more billing data parameters comprises determining a threshold payment amount equal to the historical payment amount and wherein comparing comprises comparing the threshold payment amount with a requested payment amount corresponding to billing information extracted from the invoice. In other such embodiments, the historical payment amount is an average of a plurality of payment amounts within the geographic region for the type of work.

In some embodiments, the historical payment amount is a median of a plurality of payment amount within the geographic region for the type of work.

In some embodiments, the processing device is further configured for initiating escalation for additional consideration of the invoice if the invoice is not approved.

In some embodiments, comparing comprises comparing retrieved historical billing data associated with a similar geographic region to the geographic region wherein the work is to be or has been performed with billing information extracted from the invoice.

According to embodiments of the invention, a computer program product comprises a non-transient computer-readable memory including computer-executable instructions for evaluating an invoice for work. The instructions include instructions for determining one or more billing data parameters based on information associated with the invoice or the work; instructions for retrieving from a historical billing database, historical billing data corresponding to the one or more determined billing data parameters; instructions for comparing, using a processing device, the retrieved historical billing data with at least a portion of the information extracted from the invoice; and instructions for determining whether to approve the invoice based on the comparison. In some such embodiments, the instructions for determining one or more billing data parameters comprise instructions for determining a geographical parameter based on geographic information corresponding to the geographic region wherein the work is to be or has been performed. In some such embodiments, the instructions for comparing comprise instructions for comparing retrieved historical billing data associated with the geographic region wherein the work is to be or has been performed with billing information extracted from the invoice.

In other such embodiments, the instructions for determining one or more billing data parameters comprise instructions for determining a threshold payment amount; and the instructions for comparing the retrieved historical billing data with at least a portion of the information extracted from the invoice comprise instructions for comparing the threshold payment amount with a requested payment amount corresponding to billing information extracted from the invoice. In some such embodiments, determining whether to approve the invoice is dependent upon the comparison of the threshold payment amount with the requested payment amount corresponding to billing information extracted from the invoice. In some such embodiments, the instructions for determining whether to approve the invoice comprise instructions for determining to approve the invoice when the billing information extracted from the invoice indicates a requested payment amount less than or equal to the threshold payment amount. In other such embodiments, the instructions for determining whether to approve the invoice comprise instructions for determining not to approve the invoice if the billing information extracted from the invoice indicates a requested payment amount greater than the threshold payment amount.

In some embodiments, the instructions for determining one or more parameters comprise instructions for determining a geographic parameter based on geographic information corresponding to the geographic region wherein the work is to be or has been performed; instructions for determining a type of work parameter based on the type of work associated with the invoice; instructions for determining a historical payment amount based on the determined geographic parameter and the type of work parameter, such that the historical payment amount relates to the historical payment required within the geographic region corresponding to the geographic information for the type of work associated with the invoice. In some such embodiments the instructions for determining one or more billing data parameters comprise instructions for determining a threshold payment amount equal to the historical payment amount and wherein the instructions for comparing comprise instructions for comparing the threshold payment amount with a requested payment amount corresponding to billing information extracted from the invoice. In other such embodiments, the historical payment amount is an average of a plurality of payment amounts within the geographic region for the type of work.

In some embodiments, the historical payment amount is a median of a plurality of payment amount within the geographic region for the type of work.

In some embodiments, the instructions further comprise initiating escalation for additional consideration of the invoice if the invoice is not approved.

In some embodiments, the instructions for comparing comprise instructions for comparing retrieved historical billing data associated with a similar geographic region to the geographic region wherein the work is to be or has been performed with billing information extracted from the invoice.

According to embodiments of the invention, a system for evaluating an invoice for work includes a processing device configured for determining one or more billing data parameters comprising a threshold payment amount based on information associated with the invoice or the work; retrieving from a historical billing database, historical billing data corresponding to the one or more determined billing data parameters; comparing the retrieved historical billing data including the threshold payment amount with at least a portion of the information extracted from the invoice including billing information extracted from the invoice; and determining whether to approve the invoice based on the comparison, wherein determining whether to approve the invoice is dependent upon the comparison of the threshold payment amount with the requested payment amount corresponding to billing information extracted from the invoice.

The following description and the annexed drawings set forth in detail certain illustrative features of one or more embodiments of the invention. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, wherein:

FIG. 1 is a flowchart illustrating a method for facility management according to embodiments of the invention;

FIG. 2 is a flowchart illustrating a method for preparing a work order according to embodiments of the invention;

FIG. 3 is a flowchart illustrating a method for determining whether to approve payment of an invoice according to embodiments of the invention;

FIG. 4 is a flowchart illustrating a method for retrieving key data extracted from a contract according to embodiments of the invention;

FIG. 5 is a flowchart illustrating another method for facility management according to embodiments of the invention;

FIG. 6 is a flowchart illustrating a method for evaluating contract quality according to embodiments of the invention;

FIG. 7 is a flowchart illustrating another method for evaluating contract quality according to embodiments of the invention;

FIG. 8 is a flowchart illustrating a method for evaluating capital for replacement according to embodiments of the invention;

FIG. 9 is a flowchart illustrating a method for evaluating requests using historical benchmarking according to embodiments of the invention; and

FIG. 10 is a block diagram illustrating an environment wherein a facility management system and various methods of this disclosure operate according to embodiments of the invention.

### DETAILED DESCRIPTION OF EMBODIMENTS OF THE INVENTION

This application is filed concurrently with the following related applications: Ser. No. ______, titled “Integrated Facility Management System”; Ser. No. ______, titled “Evaluating Contract Quality”; and Ser. No. ______, titled “Evaluating Capital for Replacement”, each incorporated by reference herein in their entirety and each assigned to the assignee of this application.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the invention provide systems, methods and computer program products for evaluating requests, such as requests for payment via invoice, using historical benchmarking. In some embodiments, a system for evaluating an invoice for work includes a processing device configured for determining one or more billing data parameters comprising a threshold payment amount based on information associated with the invoice or the work, retrieving from a historical billing database, historical billing data corresponding to the one or more determined billing data parameters, comparing the retrieved historical billing data including the threshold payment amount with at least a portion of the information extracted from the invoice including billing information extracted from the invoice, and determining whether to approve the invoice based on the comparison, wherein determining whether to approve the invoice is dependent upon the comparison of the threshold payment amount with the requested payment amount corresponding to billing information extracted from the invoice.

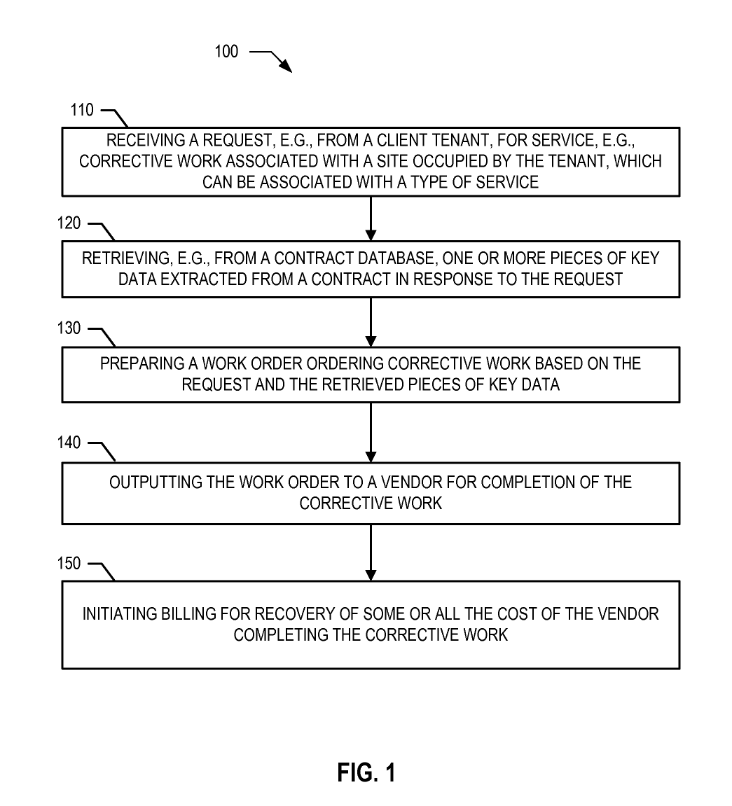

Referring now to FIG. 1, a flowchart illustrates a method 100 for facility management according to embodiments of the invention. As represented by block 110, the first step is receiving a request for service. In some embodiments, the request for service, for example, is a request originating from a client such as a tenant. In some embodiments, the request for service is for corrective work associated with a site occupied by the tenant. In some embodiments, for example, the request involves necessary repairs or maintenance needed for an asset. The request, in some embodiments, can be associated with a type of service. For example, a request for service may be a request from a tenant to repair a non-working air conditioner. The type of service associated with this request, in some embodiments, is an air conditioner repair. As another example, a request may come from a client and indicate that a water leak is accumulating on the fifth floor of a building. In such a situation, the type of service associated with the request may be a water leak. In some embodiments, the request itself includes information related to the type of service, location of service, and/or person requesting service. For example, in one embodiment, the request for service includes fields explicitly setting forth this information. In another embodiment, for example, the request for service is generated from an automated system, such as a computer system maintained by a client, and indicates, in various instances, the type of service requested as well as other information. Other information that may be included with a request for service is the date and/or time the request is made as well as the date and/or time the requester would like to have the service performed and/or completed.

As represented by block 120, the next step in the method 100 is to retrieve one or more pieces of key data extracted from a contract in response to the request. In some embodiments, a contract database stores information including abstract key data extracted manually and/or automatically from one or more contracts. In some embodiments, for example, the contracts are executed between a facility management enterprise or entity and a vendor. In such an arrangement the facility management enterprise has typically contracted with the vendor so that the vendor can provide some service to a property and/or an asset maintained by the facility management enterprise. Key data is then extracted from the contract either manually and input into a contract database and/or automatically and then stored in the contract database. In one embodiment, for example, key data extracted from a contract includes rates and/or prices for specific services, scope of services, sites at which services are to be performed and the like.

As represented by block 130, the next step is preparing a work order ordering corrective work based on the request and the retrieved pieces of key data. In some embodiments, this step is performed manually, in others it is performed automatically by a processing device, and in yet others part of the step is performed manually and part is performed automatically. For example, in one embodiment, a work order system having a processing device prepares a basic work order detailing the type of services ordered, the contracted price for the vendor to provide the services ordered based on the retrieved pieces of key data, and the scope of the work to be performed, for example, three light bulbs are to be changed. In one embodiment, for example, portions of preparation of the work order are performed manually, such as, for example, signing the work order or filing in the common name for the vendor if the common name was not included in the key data retrieved from the contract database.

As represented by block 140, the next step is outputting the work order to a vendor for completion of the corrective work. In some embodiments, the work order system initiates mailing of the work order by printing an envelope with appropriate addressee information and postage and places the work order inside the envelope. In other embodiments, some or all of step 140 is performed manually. In some embodiments, the work order system communicates instructions to another system and/or person to carry out the step.

As represented by block 150, the next step is initiating billing for recovery of some or all the cost of the vendor completing the corrective work. In some contracts, the tenant retains responsibility for paying for certain specified expenses such as, for example, routine maintenance. One example may be changing an air conditioner filter. If the tenant is contractually responsible for particular expenses and/or services provided by a vendor through the facility management enterprise, then a billing system, in some embodiments, passes some or all the cost of such expenses to the tenant. In some embodiments, a billing system is connected with a facility management system including the contract database, and the billing system accesses the contract database in order to determine whether a particular expense and/or work being performed is the tenant's responsibility based on a lease contract having data stored in the contract database. In this regard, the contract database stores information related to different types of contracts. In some other embodiments, multiple databases are used for data regarding different types of contracts. Of course, in many embodiments, no contractual arrangement between the tenant and the facility management enterprise has been reached, and the enterprise is liable for most or all maintenance of the site. In other situations, there is an inherent or assumed duty of the tenant and/or the landlord/enterprise to perform particular types of maintenance.

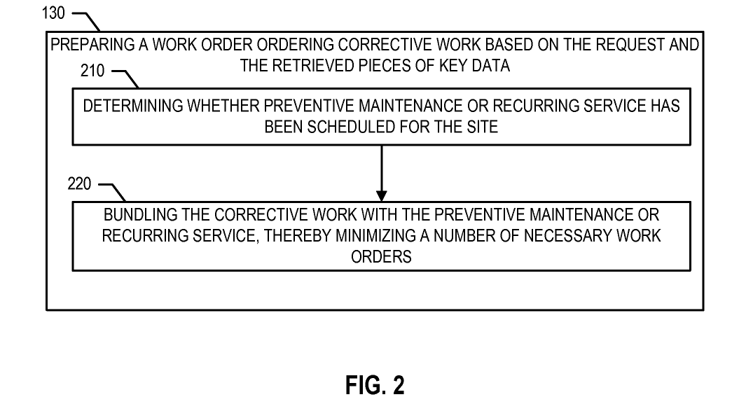

Referring now to FIG. 2, a flowchart illustrates a method 130 for preparing a work order according to embodiments of the invention. This method 130 is step 130 as originally presented in FIG. 1 with additional detail corresponding to various embodiments of the invention. The first sub-step, as represented by block 210, is determining whether preventive maintenance and/or recurring service have been scheduled for the site for which the request was directed. In other embodiments, step 210 includes determining whether preventive maintenance and/or recurring service have been scheduled for a particular asset and/or a particular group of assets.

The next step, as represented by block 220, is bundling the corrective work with the preventive maintenance and/or recurring service, thereby minimizing a number of necessary work orders. Bundling the corrective work with the previously scheduled or soon to be scheduled preventive work may reduce the number of trips a vendor must make to a particular site and/or to a particular asset and/or group of assets. Furthermore, bundling the requested work with the preventive work generally reduces expenses for the responsible party, that is, the enterprise and/or the tenant.

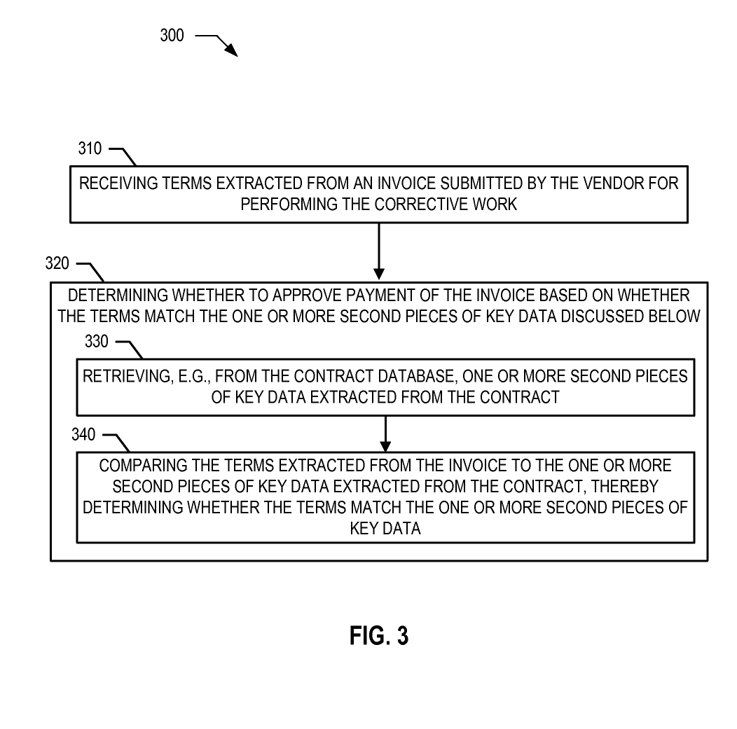

Referring now to FIG. 3, a flowchart illustrates a method 300 for determining whether to approve payment of an invoice according to embodiments of the invention. The first step of the method 300, as represented by block 310 is receiving terms extracted from an invoice submitted by the vendor for performing the corrective work. In some embodiments, step 310 comprises retrieving terms extracted from an invoice from a database, such as the contract database or some other database. In some embodiments, the terms extracted from the vendor invoice are extracted automatically, such as, for example, by the facility management system. In some embodiments, the vendor submits information regarding its invoice via a standardized form with filling fields captured and/or received by the facility management system. In this regard, the vendor can input information regarding the invoice without presenting a physical invoice to the enterprise. In some embodiments, the vendor submits either a physical invoice and/or an electronic invoice but the invoice does not have metadata or data captured in recognized fields. Accordingly, relevant terms are captured and/or received either manually, automatically by, for example, a facility management system, and/or a combination of manually and automatically.

The next step, as represented by block 320 is determining whether to approve payment of the invoice based on whether the terms match the one or more second pieces of key data discussed below. Sub-step 330 is retrieving one or more second pieces of key data extracted from the contract, for example, from the contract database. Sub-step 340 is comparing the terms extracted from the invoice to the one or more second pieces of key data extracted from the contract, thereby determining whether the terms match the one or more second pieces of key data. In some embodiments, for example, the terms extracted from the invoice and the second pieces of data extracted from the contract represent the vendor's price for performing the service and the contract price for performing the service, respectively. In some embodiments, a so-called “three-way” match is performed such that the contract data or terms, the work order data or terms, and the invoice data or terms are all matched using the facility management system. In this regard, for example, the contracted price is used to prepare the work order, and the invoice is compared against the contracted price in order to approve the invoice. This is made possible by the consolidation of key data from the contract, preparation of the work orders and receipt and analysis of the invoice terms.

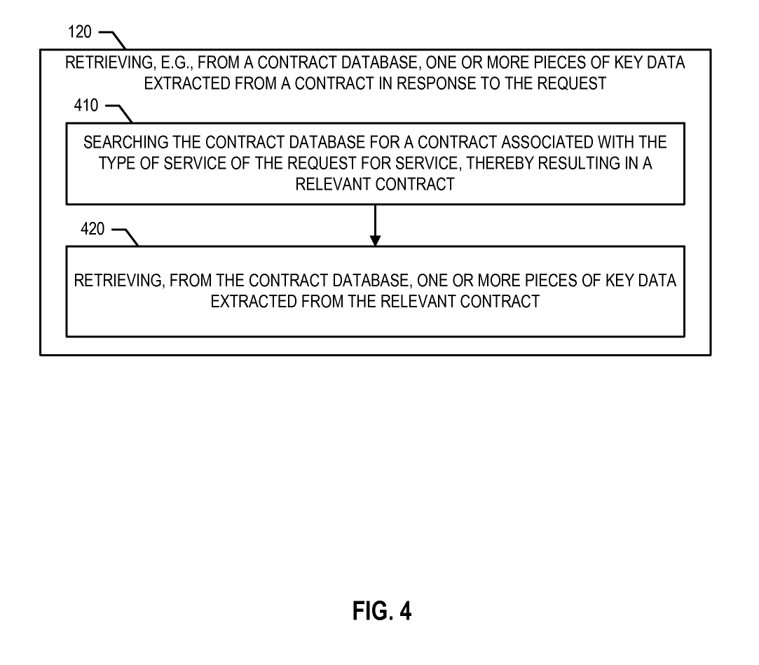

Referring now to FIG. 4, a flowchart illustrates a method 120, first presented as step 120 in FIG. 1, for retrieving key data extracted from a contract according to embodiments of the invention. In block 120, one or more pieces of key data extracted from a contract are retrieved in response to a request for service. Sub-step 410 is searching the contract database for a contract associated with the type of service of the request for service, thereby resulting in a relevant contract being found in some instances. Of course, in some instances, a relevant contract is not found, and, in some embodiments, such a situation dictates escalation of the issue to a user of the facility management system. Sub-step 420 is retrieving, from the contract database, for example, one or more pieces of key data extracted from the relevant contract.

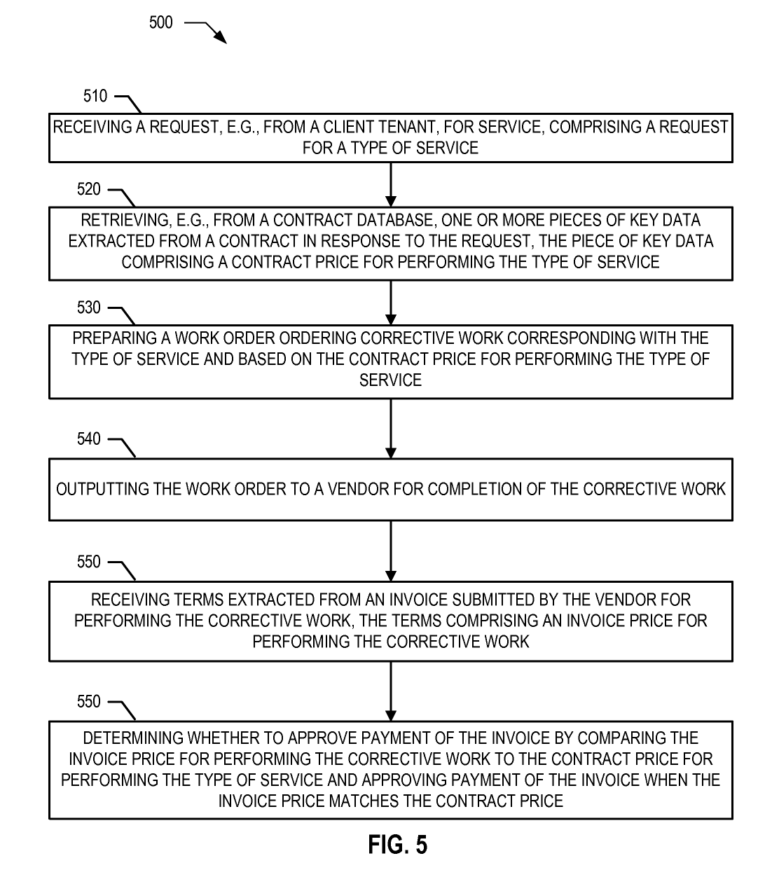

Referring now to FIG. 5, a flowchart illustrates another method 500 for facility management according to embodiments of the invention. The first step, as represented by block 510, is receiving a request, for example, from a client and/or a tenant, for service. In some embodiments, the request includes a request for a type of service as discussed above. The next step, as represented by block 520, is retrieving, for example, from a contract database, one or more pieces of key data extracted from a contract in response to the request. The pieces of key data including, in some embodiments, a contract price for performing or completing the type of service, that is, the work requested. The next step, as represented by block 530, is preparing a work order ordering the corrective work corresponding with the type of service and based on the contract price for performing the type of service or work requested. The next step, as represented by block 540, is outputting the work order to a vendor for completion of the corrective work, and the next step, as represented by block 550, is receiving terms extracted from an invoice submitted by the vendor for performing the corrective work. In some embodiments, as discussed above, the terms include an invoice price for performing the corrective work. The final step, as represented by block 550, is determining whether to approve payment of the invoice by comparing the invoice price for performing the corrective work to the contract price for performing the type of service. Payment of the invoice, in some embodiments, is approved when the invoice price matches the contract price. In some embodiments, when the invoice price does not match the contract price, payment of the invoice is not approved. In some such situations, the facility management system escalates the issue so that a user of the system can take the proper action.

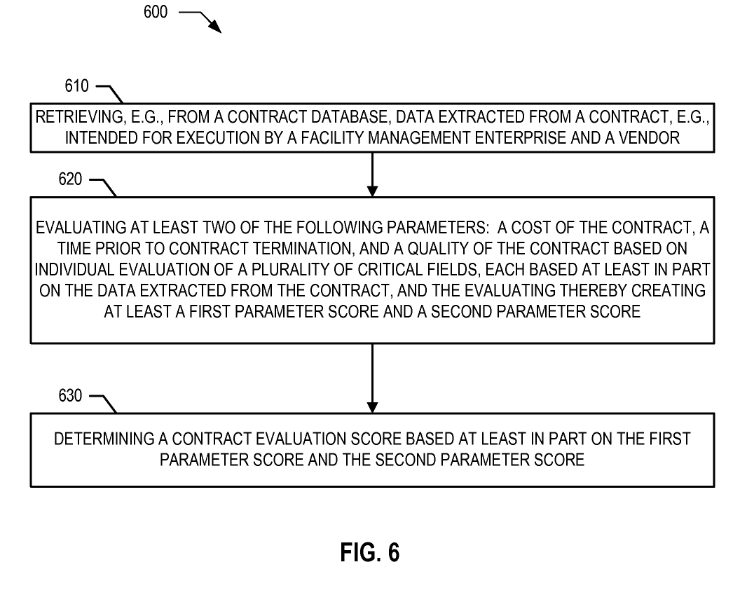

Referring now to FIG. 6, a flowchart illustrates a method 600 for evaluating contract quality according to embodiments of the invention. The method 600 may be executed by the facility management system or some other system in various embodiments. The first step, as represented by block 610, is retrieving data extracted from a contract, for example, from a contract database as discussed above. In some embodiments, the next step, as represented by block 620, is evaluating at least two of the following parameters: (1) a cost of the contract; (2) a time prior to contract termination; and (3) a quality of the contract based on individual evaluation of a plurality of critical fields. Each field is based at least in part on the data extracted from the contract in some embodiments. The evaluating step 620 creates at least a first parameter score and a second parameter score. Finally, the next step, as represented by block 630, is determining a contract evaluation score based at least in part on the first parameter score and the second parameter score.

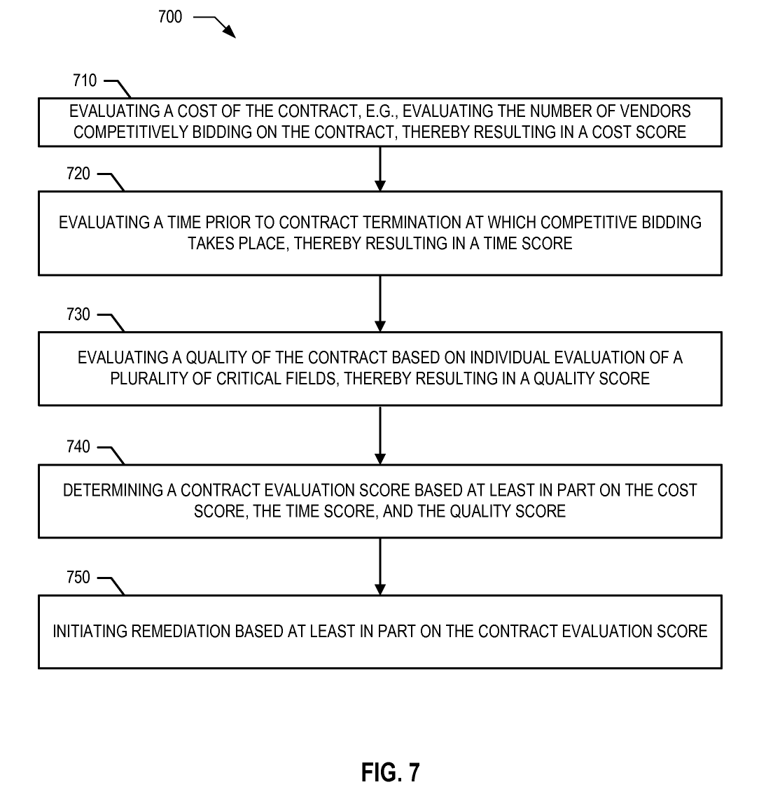

Referring now to FIG. 7, a flowchart illustrates another method 700 for evaluating contract quality according to embodiments of the invention. In this method 700, each of the three parameters are evaluated and used to determine a contract evaluation score as discussed further below. The first step, as represented by block 710, is evaluating a cost of the contract, for example, evaluating the number of vendors competitively bidding on the contract, thereby resulting in a cost score. Hence, the cost score is representative of number of bids going into the cost score in such embodiments. In various other embodiments, other methods are used to determine the cost score, such as comparing the price associated with the contract and comparing it to a normative or average price for a particular type of work, for example, in the same or a similar geographic area, such as that described with regard to the method for evaluating requests using benchmarking below.

The next step, as represented by block 720, is evaluating a time prior to contract termination at which competitive bidding takes place, thereby resulting in a time score. This step accounts for the longevity of the contract past its explicit termination date by considering the renegotiation of the contract. This is beneficial for numerous reasons including a facility management enterprise's desire to eliminate contractual gaps with vendors.

The next step, as represented by block 730, is evaluating a quality of the contract based on individual evaluation of a plurality of fields deemed to be critical to contract quality, thereby resulting in a quality score. In various embodiments a wide variety of critical fields are considered. In some embodiments, for example, one or more of the following fields are considered critical: vendor name, effective date, expiration dates, term, termination notice period, month-to-month terms, payment days, payment method, invoice billing requirement, supplier diversity spend, fee schedule, work order service level agreements (SLA), sub-contractor requirements, indemnity, workers compensation insurance, business automobile liability, location serviced, and/or contracts and amendments executed. The measurement of the vendor name field is whether the field is populated in the contract. If so it receives a positive individual critical field score. All the individual critical field scores are used to determine the parameter score for the quality parameter, which is also referred to herein as the quality score. The measurement of the effective data field is whether the field is populated in the contract, and if so, it receives a positive score. The measure of the expiration dates field is whether the expiration dates of the contract match any expiration dates on amendments to the contract, and if so, it receives a positive score. The term field is given a positive score if less than or equal to thirty-six months, and the termination notice period is given a positive score if less than or equal to thirty days. The month-to-month terms is given a positive score if true, and the payment days field is given a positive score is less than or equal to forty-five days. The payment method field is given a positive score if method is the Automated Clearing House (ACH), and the invoice billing requirement is given a positive score if less than or equal to thirty days. The supplier diversity spending field is given a positive score if the contract includes diversity spending language, and the fee schedule field is given a positive score if a simple structure, that is, a fee schedule having a structure defined as a labor rate with standard and overtime rates only, is used. The work order SLA field is given a positive score if the contract has a five day response time for normal work, twenty-four hour response time for rush work, and four hour response time for emergency work. The sub-contractor requirements field is given a positive score if the minimum requirement is at least an equivalent of “consent required.” The indemnity field is given a positive score if indemnity is specified in the contract. The workers compensation insurance field is given a positive score if there is coverage, and the business automobile liability is given a positive score if there is coverage. The location serviced field is given a positive score if it is present in the contract, and the contracts and amendments executed field is given a positive score if a signature is present on the contract.

In various embodiments, of course, numerous different combinations of the above fields in addition to other fields are used to determine the quality score for a contract. In some embodiments, for example, a maximum possible score of one hundred is assigned to the quality score and each field deemed critical is analyzed and the individual critical field scores are summed to determine the quality score. In various other embodiments, different scoring mechanisms are used, such as weighting each of the individual critical field scores before using them to determine the quality score.

The next step, as represented by block 740, is determining a contract evaluation score (CES) based at least in part on the cost score, the time score, and the quality score. In some embodiments, for example, each of the three scores is weighted evenly, and in other embodiments, the three scores are given weight according to their perceived indication of overall contract evaluation.

In various embodiments, evaluating the number of vendors competitively bidding on the contract includes assigning a value of zero to the cost score when only one vendor bids on the contract, assigning a half-maximum value to the cost score when two vendors bid on the contract, and assigning a maximum value to the cost score when three or more vendors bid on the contract. In various other embodiments, evaluating the number of vendors competitively bidding on the contract includes assigning different values to the cost score under various circumstances. For example, in one embodiment, the relevant thresholds for numbers of vendor are higher or lower, and in some embodiments, the number of thresholds is higher or lower such that the potential values of the cost score increase or decrease. As a more specific example, the cost score, in one embodiment, can be any five different values ranging from a minimum value to a maximum value based on the number of thresholds being considered for the number of vendors competitively bidding on the contract. For example, in one instance, the number of vendors competitively bidding on the contract is evaluated by assigning the lowest cost score to contracts having only one vendor bidding, a second lowest cost score to contracts having two vendors bidding, a third lowest cost score to contracts having three vendors bidding, and so forth.

Furthermore, in some embodiments, the cost scores assigned in the various situations reflect a weighted value. For example, in one embodiment, when only one vendor bids on a contract, the minimum score is assigned to the cost score, such as a score of zero. However, in this example, there are additional thresholds, such that the scores vary if there are two vendors, three vendors, four vendors, or five vendors or more vendors bidding on the contracts. As the number of vendors increases, however, the effect on the cost score changes. For example, if two vendors bid on the contract, the cost score is assigned 50% of the maximum, if three vendors bid on the contract, the cost score is assigned 80% of the maximum, if four vendors bid on the contract, the cost score is assigned 95% of the maximum, and if five or more vendors bid on the contract, the cost score is assigned 100% of the maximum. In this regard, the cost score reflects the diminishing value of having additional vendors bidding on the contract.

In various embodiments, evaluating the time prior to contract termination at which competitive bidding takes place includes assigning a value of zero to the time score when no competitive bidding is scheduled during the contract term. In such embodiments, a half-maximum value is assigned to the time score when competitive bidding is scheduled between one month prior to termination of the contract and termination of the contract. A maximum value is assigned to the time score when competitive bidding is scheduled greater than one month prior to the termination of the contract.

In various other embodiments, evaluating the time prior to contract termination at which competitive bidding takes place includes assigning different values to the time score in different scenarios. For example, in some embodiments, different lengths of time before termination of the contract are used as threshold values in order to evaluate the time prior to contract termination for competitive bidding. In one specific example, a threshold is set at three months, one is set at six months, and one is set at nine months prior to contract termination. In such embodiments, the lowest time score is assigned a contract having no competitive bidding prior to termination, but a score of 75% of maximum is assigned to a contract having competitive bidding three months prior to termination, 85% to a contract having competitive bidding six months prior to termination, and 95% to a contract having competitive bidding nine months prior to termination. In various other embodiments, different scoring thresholds are established and used to assign the time scores for contracts having different times before termination for bidding. In various embodiments, additional thresholds are set and in other embodiments, fewer thresholds are set.

In various embodiments, as discussed above, evaluating the quality of the contract includes determining an individual critical field score for each critical field and summing, or otherwise combining the individual critical field scores, in order to determine the quality score. In some embodiments, remediation is initiated, as represented by block 750. In some embodiments, for example, if the CES is above a predetermined threshold, the facility management system will escalate the issue for a user of the system to determine the proper course of action. In other embodiments, the system has instructions stored for automatically remediating, such as, for example, initiating a contract non-approval notice and/or initiating a contract approval notice.

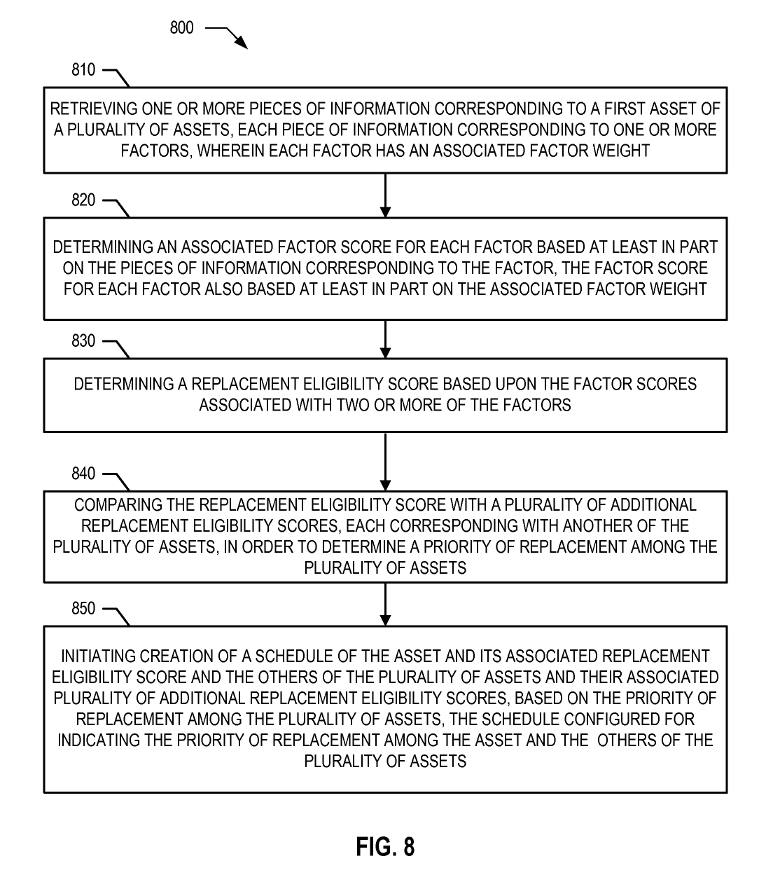

Referring now to FIG. 8, a flowchart illustrates a method 800 for evaluating capital for replacement according to embodiments of the invention. The first step, as represented by block 810 is retrieving one or more pieces of information corresponding to a first asset of a plurality of assets. Each piece of information corresponds to one or more factors, wherein each factor has an associated factor weight. The next step, as represented by block 820, is determining an associated factor score for each factor based at least in part on the pieces of information corresponding to the factor. The factor score for each factor is also based at least in part on the associated factor weight. The next step, as represented by block 830 is determining a replacement eligibility score based upon the factor scores associated with two or more of the factors. The next step, as represented by block 840, is comparing the replacement eligibility score with a plurality of additional replacement eligibility scores, each corresponding with another of the plurality of assets, in order to determine a priority of replacement among the plurality of assets. In some embodiments, the method 800 also includes, as represented by block 850, initiating creation of a schedule of the asset and its associated replacement eligibility score and the rest of the plurality of assets and their associated replacement eligibility scores. The schedule is created, in some embodiments, based on the priority of replacement among the plurality of assets. The schedule is configured for indicating the priority of replacement among the asset and the rest of the plurality of assets.

In various embodiments, one or more of the following factors may be used: life expectancy versus actual age, number of corrective work orders in past year, number of failures in past year, average condition, for example, the last two years, latest condition, change from latest condition to current condition, critical function, parts availability, and operational conflict with design and construction. Operational conflict with design and construction, in some embodiments, indicates whether the asset is performing to achieve the goals it was designed to achieve, such as an air conditioner cooling a space. Various factors are measured and/or determined by a vendor or other worker and information regarding the asset is input into the facility management system, such as into a database. Some information regarding the asset that may be stored in the system and used to calculate one or more factors includes the average life expectancy, the age, and the life expectancy versus actual age percentage. Some factor information that may be stored in the system based on historical work orders includes in various embodiments number of corrective work orders in past year and the number of failures over the life of the asset. Some factor information that may be stored in the system based on information captured during inspections, such as, for example, during a preventive maintenance session include the average condition the last two years, the change from latest condition to current condition, the latest condition, the critical function, the availability of parts, the operational conflict with design and construction, and, in some embodiments, textual comments related to replacement of the asset.

In some embodiments, the replacement eligibility score is calculated by the facility management system based on the following steps. First, the total factor score is the summation of the factor score associated with each factor for the asset. Second, the maximum possible weighted score for each factor is determined by multiplying the maximum possible unweighted scores for each factor by the associated factor weight. Third, the total maximum possible score is the summation of the maximum possible weighted scores. Fourth, and finally, the replacement eligibility score for the asset is determined by dividing the total factor score by the total maximum possible score. In various other embodiments, other steps are used to calculate the retirement eligibility scores, using various combinations of weighting and arithmetic. For example, in one embodiment, weightings are not used, but rather, the scores themselves. In such embodiments, therefore, each factor is weighted evenly.

In some embodiments, a single asset may be evaluated for replacement. In such a case, the method includes steps similar to those discussed with reference to FIG. 8. The first step, in various embodiments, is to retrieve one or more pieces of information corresponding to the asset. Each piece of information corresponds to one or more factors, each typically having an associated factor weight. The factor weight is a predetermined weighting value based on the importance of each factor, as compared to the other factors, for indicating replacement of the asset. For example, in one embodiment, the actual age versus expected retirement age factor is given substantial weight whereas the number of corrective work orders in the past year factor is given much less weight. As a result, even a low individual factor score for a highly weighted factor may be very significant in ultimately determining whether an asset should be retired. The next step, in various embodiments, is determining as associated factor score for each factor based at least in part on the pieces of information corresponding to the factor. The factor score for each factor is also based at least in part on the associated factor weight. In some embodiments, for example, the factor weight is multiplied by the individual factor score to determine an individual weighted factor score. Next, a replacement eligibility score is determined based upon the factor scores associated with two or more factors. In embodiments where only a single replacement eligibility score is calculated, that is, when only one asset is being evaluated, the score can provide context to the user for determining whether to replace the asset or schedule the asset for replacement. For example, in one embodiment, the replacement eligibility score for the asset is compared to a predetermined threshold score, above which an asset is deemed to require replacement, and below which an asset is deemed not to require replacement. In other embodiments, for example, the replacement eligibility score for the asset is compared to ranges indicating that the asset should be replaced, re-evaluated at a later date, watched very carefully, and/or scheduled for immediate replacement. In various other embodiments, other ranges and/or indications from the ranges and/or thresholds are used to gain context from the replacement eligibility score.

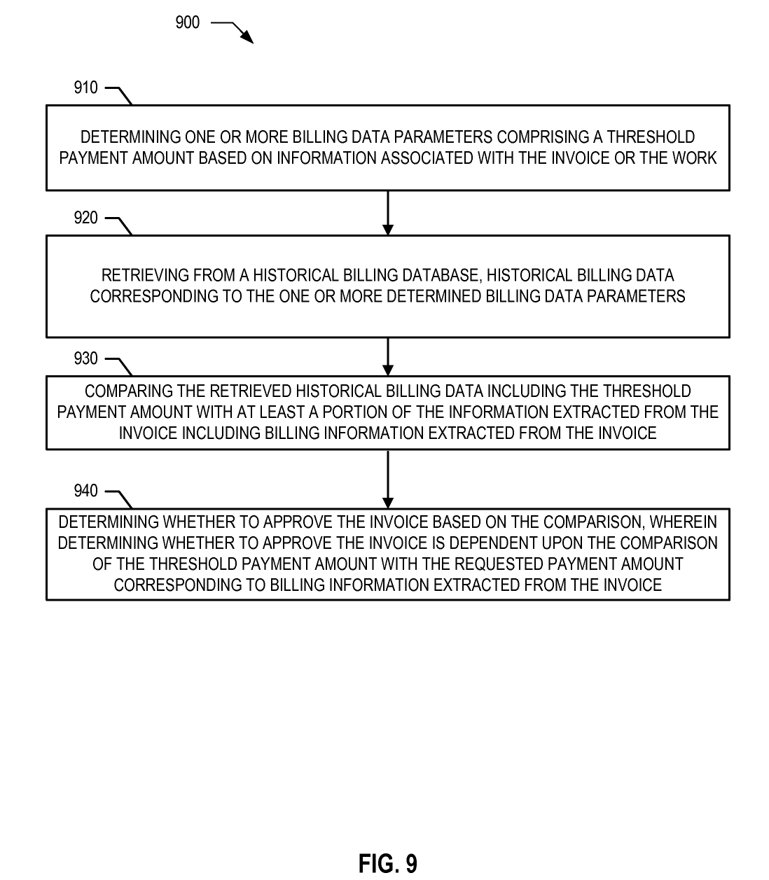

Referring now to FIG. 9, a flowchart illustrates a method 900 for evaluating requests using historical benchmarking according to embodiments of the invention. The first step, as represented by block 910, is determining one or more billing data parameters including a threshold payment amount based on information associated with the invoice or the work. The next step, as represented by block 920, is retrieving from a historical billing database, historical billing data corresponding to the one or more determined billing data parameters. The next step, as represented by block 930, is comparing the retrieved historical billing data including the threshold payment amount with at least a portion of the information extracted from the invoice including billing information extracted from the invoice. Fourth, and finally, as represented by block 940, the next step is determining whether to approve the invoice based on the comparison, wherein determining whether to approve the invoice is dependent upon the comparison of the threshold payment amount with the requested payment amount corresponding to billing information extracted from the invoice.

In some embodiments, the historical billing data corresponds with the geographical area in which the work will take place. In other embodiments, there is no historical billing data related to the type of work requested available in the geographic area in which the work is to take place. In such a case, and in other cases as well, when desired, the system can retrieve historical billing data from a similar geographic region in order to determine a threshold. In one embodiment, for example, a work order for replacement of a particular type of roofing shingle is prepared, and a vendor bids on the work. However, the database contains no similar history work being performed associated with the present city. In such a case, the system is instructed to look in one or more other cities of comparable size and location and, in some embodiments, other comparison factors such as population density, cost of living and the like. Referring back to the example above, the system may consider Atlanta a substitute for Charlotte. Thus, if the work order for the particular type of roof repair in Charlotte did not match any data within the database, then the system would look to the predetermined similar geographic region of Atlanta to determine whether there is any historical data regarding the type of work, that is, the particular type of roof repair in order that the system could determine an appropriate price for the work to be performed. In one embodiment, for example, the billing data parameters include a geographical parameter based on the geographic information corresponding to the geographic region wherein the work is to be or has been performed.

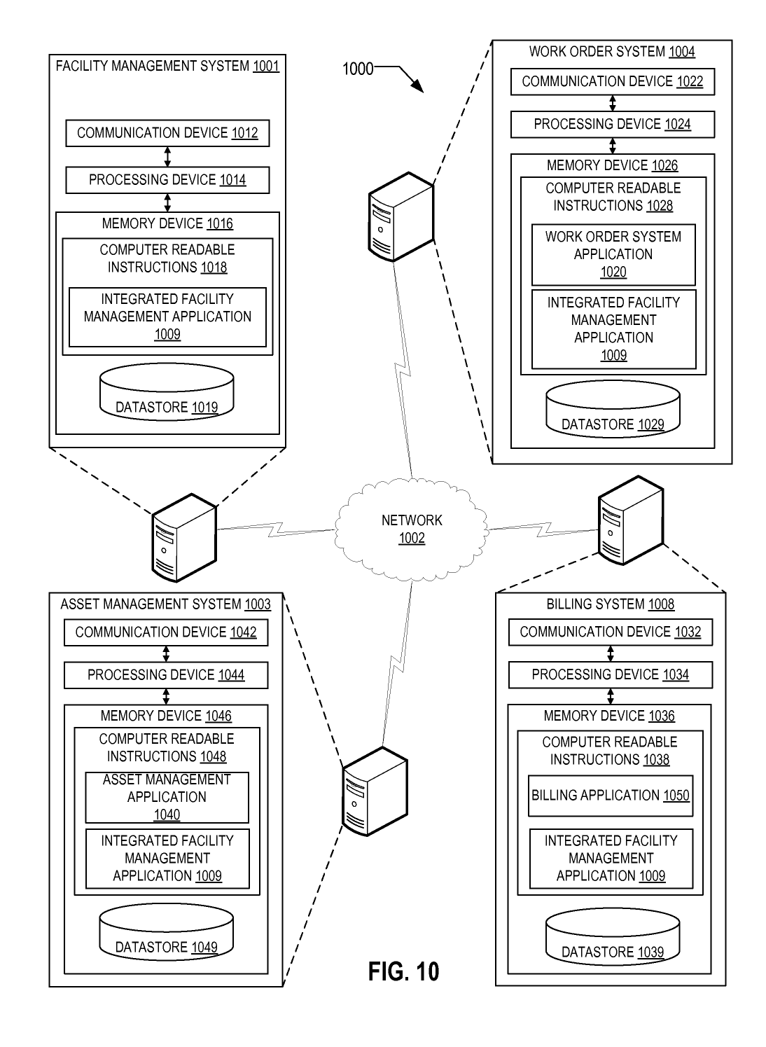

Referring now to FIG. 10, a block diagram illustrates an environment 1000 wherein a facility management system 1001 and the various methods of the invention operate according to various embodiments. A facility management system 1001 is a computer system, server, multiple computer systems and/or servers or the like. The facility management system 1001, in the embodiments shown has a communication device 1012 communicably coupled with a processing device 1014, which is also communicably coupled with a memory device 1016. The processing device is configured to control the communication device 1012 such that the facility management system 1001 communicates across the network 1002 with one or more other systems. The processing device is also configured to access the memory device 1016 in order to read the computer readable instructions 1018, which in some embodiments includes an integrated facility management application 1009. The memory device 1016 also has a datastore 1019 or database for storing pieces of data for access by the processing device 1014.

The facility management application 1009 is configured for instructing the processing device 1014 to perform various steps of the methods discussed herein, and/or other steps and/or similar steps. In various embodiments, the facility management application 1009 is included in the computer readable instructions stored in a memory device of one or more systems other than the facility management system 1001. For example, in some embodiments, the facility management application 1009 is stored and configured for being accessed by a processing device of one or more other systems connected with the facility management system 1001 through network 1002.

A work order system 1004 is configured for preparing work order among other functions as discussed above. The work order system 1004 is a computer system, server, multiple computer system, multiple servers, a mobile device or some other computing device configured for use by a user. The work order system 1004 has a communication device 1022 communicatively coupled with a processing device 1024, which is also communicatively coupled with a memory device 1026. The processing device 1024 is configured to control the communication device 1022 such that the work order system 1004 communicates across the network 1002 with one or more other systems. The processing device 1024 is also configured to access the memory device 1026 in order to read the computer readable instructions 1028, which in some embodiments include a work order system application 1020. The memory device 1026 also has a datastore 1029 or database for storing pieces of data for access by the processing device 1024. The work order application 1020 is configured to prepare work orders for outputting to the vendor.

The asset management system 1003 is configured for providing one or more of the pieces of data used by the facility management system 1001 when running the facility management application 1009 as discussed herein. In some embodiments, the asset management system 1003 includes a communication device 1042 communicatively coupled with a processing device 1044, which is also communicatively coupled with a memory device 1046. The processing device 1034 is configured to control the communication device 1042 such that the asset management system 1003 communicates across the network 1002 with one or more other systems. The processing device 1044 is also configured to access the memory device 1046 in order to read the computer readable instructions 1048, which in some embodiments include instructions for communicating with the facility management system 1001, and in some embodiments, includes some or all of the facility management application 1009.

The billing system 1008 is configured for providing one or more of the pieces of data used by the facility management system 1001 when running the facility management application 1009 as discussed herein. In some embodiments, the billing system 1008 includes a communication device 1032 communicatively coupled with a processing device 1034, which is also communicatively coupled with a memory device 1036. The processing device 1034 is configured to control the communication device 1032 such that the billing system 1008 communicates across the network 1002 with one or more other systems. The processing device 1034 is also configured to access the memory device 1036 in order to read the computer readable instructions 1038, which in some embodiments include instructions for communicating with the facility management system 1001, and in some embodiments, includes some or all of the facility management application 1009. In some embodiments, the billing system also includes a separate billing application 1050 and a datastore 1039.

In various embodiments, one of the systems discussed above, such as the facility management system 1001, is more than one system and the various components of the system are not collocated, and in various embodiments, there are multiple components performing the functions indicated herein as a single device. For example, in one embodiment, multiple processing devices perform the functions of the processing device 1014 of the financial institution system 1001 described herein. In various embodiments, the facility management system 1001 includes one or more of the work order system 1004, the asset management system 1003, the billing system 1008, and/or any other system or component used in conjunction with or to perform any of the method steps discussed herein.

Embodiments of the invention provide systems, methods and computer program products for evaluating requests, such as requests for payment via invoice, using historical benchmarking. In some embodiments, a system for evaluating an invoice for work includes a processing device configured for determining one or more billing data parameters comprising a threshold payment amount based on information associated with the invoice or the work, retrieving from a historical billing database, historical billing data corresponding to the one or more determined billing data parameters, comparing the retrieved historical billing data including the threshold payment amount with at least a portion of the information extracted from the invoice including billing information extracted from the invoice, and determining whether to approve the invoice based on the comparison, wherein determining whether to approve the invoice is dependent upon the comparison of the threshold payment amount with the requested payment amount corresponding to billing information extracted from the invoice.

As used herein, a “processing device” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities.

As used herein, a “communication device” generally includes a modem, server, transceiver, and/or other device for communicating with other devices directly or via a network, and/or a user interface for communicating with one or more users. As used herein, a “user interface” generally includes a display, mouse, keyboard, button, touchpad, touch screen, microphone, speaker, LED, light, joystick, switch, buzzer, bell, and/or other user input/output device for communicating with one or more users.

As used herein, a “memory device” or “memory” generally refers to a device or combination of devices including one or more forms of non-transitory computer-readable media for storing instructions, computer-executable code, and/or data thereon. Computer-readable media is defined in greater detail herein below. It will be appreciated that, as with the processing device, each communication interface and memory device may be made up of a single device or many separate devices that conceptually may be thought of as a single device.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor/processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. A method for evaluating an invoice for work, the method comprising:
determining one or more billing data parameters based on information associated with the invoice or the work;
retrieving from a historical billing database, historical billing data corresponding to the one or more determined billing data parameters;
comparing, using a processing device, the retrieved historical billing data with at least a portion of the information extracted from the invoice; and
determining whether to approve the invoice based on the comparison.

2. The method of claim 1, wherein determining one or more billing data parameters comprises determining a geographical parameter based on geographic information corresponding to the geographic region wherein the work is to be or has been performed.

3. The method of claim 2, wherein comparing comprises comparing retrieved historical billing data associated with the geographic region wherein the work is to be or has been performed with billing information extracted from the invoice.

4. The method of claim 1, wherein:
determining one or more billing data parameters comprises determining a threshold payment amount; and
comparing the retrieved historical billing data with at least a portion of the information extracted from the invoice comprises comparing the threshold payment amount with a requested payment amount corresponding to billing information extracted from the invoice.

5. The method of claim 4, wherein:
determining whether to approve the invoice is dependent upon the comparison of the threshold payment amount with the requested payment amount corresponding to billing information extracted from the invoice.

6. The method of claim 5, wherein:
determining whether to approve the invoice comprises determining to approve the invoice when the billing information extracted from the invoice indicates a requested payment amount less than or equal to the threshold payment amount.

7. The method of claim 5, wherein:
determining whether to approve the invoice comprises determining not to approve the invoice if the billing information extracted from the invoice indicates a requested payment amount greater than the threshold payment amount.

8. The method of claim 1, wherein determining one or more parameters comprises:
determining a geographic parameter based on geographic information corresponding to the geographic region wherein the work is to be or has been performed;
determining a type of work parameter based on the type of work associated with the invoice; and
determining a historical payment amount based on the determined geographic parameter and the type of work parameter, such that the historical payment amount relates to the historical payment required within the geographic region corresponding to the geographic information for the type of work associated with the invoice.

9. The method of claim 8, wherein determining one or more billing data parameters comprises determining a threshold payment amount equal to the historical payment amount and wherein comparing comprises comparing the threshold payment amount with a requested payment amount corresponding to billing information extracted from the invoice.

10. The method of claim 8, wherein the historical payment amount is an average of a plurality of payment amounts within the geographic region for the type of work.

11. The method of claim 8, wherein the historical payment amount is a median of a plurality of payment amount within the geographic region for the type of work.

12. The method of claim 1, further comprising initiating escalation for additional consideration of the invoice if the invoice is not approved.

13. The method of claim 2, wherein comparing comprises comparing retrieved historical billing data associated with a similar geographic region to the geographic region wherein the work is to be or has been performed with billing information extracted from the invoice.

14. A system for evaluating an invoice for work, the system comprising:
a processing device configured for:
determining one or more billing data parameters based on information associated with the invoice or the work;
retrieving from a historical billing database, historical billing data corresponding to the one or more determined billing data parameters;
comparing the retrieved historical billing data with at least a portion of the information extracted from the invoice; and
determining whether to approve the invoice based on the comparison.

15. The system of claim 14, wherein determining one or more billing data parameters comprises determining a geographical parameter based on geographic information corresponding to the geographic region wherein the work is to be or has been performed.

16. The system of claim 15, wherein comparing comprises comparing retrieved historical billing data associated with the geographic region wherein the work is to be or has been performed with billing information extracted from the invoice.

17. The system of claim 14, wherein:
determining one or more billing data parameters comprises determining a threshold payment amount; and
comparing the retrieved historical billing data with at least a portion of the information extracted from the invoice comprises comparing the threshold payment amount with a requested payment amount corresponding to billing information extracted from the invoice.

18. The system of claim 17, wherein:
determining whether to approve the invoice is dependent upon the comparison of the threshold payment amount with the requested payment amount corresponding to billing information extracted from the invoice.

19. The system of claim 18, wherein:
determining whether to approve the invoice comprises determining to approve the invoice when the billing information extracted from the invoice indicates a requested payment amount less than or equal to the threshold payment amount.

20. The system of claim 18, wherein:
determining whether to approve the invoice comprises determining not to approve the invoice if the billing information extracted from the invoice indicates a requested payment amount greater than the threshold payment amount.

21. The system of claim 14, wherein determining one or more parameters comprises:
determining a geographic parameter based on geographic information corresponding to the geographic region wherein the work is to be or has been performed;
determining a type of work parameter based on the type of work associated with the invoice; and
determining a historical payment amount based on the determined geographic parameter and the type of work parameter, such that the historical payment amount relates to the historical payment required within the geographic region corresponding to the geographic information for the type of work associated with the invoice.

22. The system of claim 21, wherein determining one or more billing data parameters comprises determining a threshold payment amount equal to the historical payment amount and wherein comparing comprises comparing the threshold payment amount with a requested payment amount corresponding to billing information extracted from the invoice.

23. The system of claim 21, wherein the historical payment amount is an average of a plurality of payment amounts within the geographic region for the type of work.

24. The system of claim 21, wherein the historical payment amount is a median of a plurality of payment amount within the geographic region for the type of work.

25. The system of claim 14, wherein the processing device is further configured for:
initiating escalation for additional consideration of the invoice if the invoice is not approved.

26. The system of claim 15, wherein comparing comprises comparing retrieved historical billing data associated with a similar geographic region to the geographic region wherein the work is to be or has been performed with billing information extracted from the invoice.

27. A computer program product comprising a non-transient computer-readable memory comprising computer-executable instructions for evaluating an invoice for work, the instructions comprising:
instructions for determining one or more billing data parameters based on information associated with the invoice or the work;
instructions for retrieving from a historical billing database, historical billing data corresponding to the one or more determined billing data parameters;
instructions for comparing, using a processing device, the retrieved historical billing data with at least a portion of the information extracted from the invoice; and
instructions for determining whether to approve the invoice based on the comparison.

28. The computer program product of claim 27, wherein the instructions for determining one or more billing data parameters comprise instructions for determining a geographical parameter based on geographic information corresponding to the geographic region wherein the work is to be or has been performed.

29. The computer program product of claim 28, wherein the instructions for comparing comprise instructions for comparing retrieved historical billing data associated with the geographic region wherein the work is to be or has been performed with billing information extracted from the invoice.

30. The computer program product of claim 27, wherein:
the instructions for determining one or more billing data parameters comprise instructions for determining a threshold payment amount; and
the instructions for comparing the retrieved historical billing data with at least a portion of the information extracted from the invoice comprise instructions for comparing the threshold payment amount with a requested payment amount corresponding to billing information extracted from the invoice.

31. The computer program product of claim 30, wherein:
determining whether to approve the invoice is dependent upon the comparison of the threshold payment amount with the requested payment amount corresponding to billing information extracted from the invoice.

32. The computer program product of claim 31, wherein:
the instructions for determining whether to approve the invoice comprise instructions for determining to approve the invoice when the billing information extracted from the invoice indicates a requested payment amount less than or equal to the threshold payment amount.

33. The computer program product of claim 31, wherein:
the instructions for determining whether to approve the invoice comprise instructions for determining not to approve the invoice if the billing information extracted from the invoice indicates a requested payment amount greater than the threshold payment amount.

34. The computer program product of claim 27, wherein the instructions for determining one or more parameters comprise:
instructions for determining a geographic parameter based on geographic information corresponding to the geographic region wherein the work is to be or has been performed;
instructions for determining a type of work parameter based on the type of work associated with the invoice;
instructions for determining a historical payment amount based on the determined geographic parameter and the type of work parameter, such that the historical payment amount relates to the historical payment required within the geographic region corresponding to the geographic information for the type of work associated with the invoice.

35. The computer program product of claim 34, wherein the instructions for determining one or more billing data parameters comprise instructions for determining a threshold payment amount equal to the historical payment amount and wherein the instructions for comparing comprise instructions for comparing the threshold payment amount with a requested payment amount corresponding to billing information extracted from the invoice.

36. The computer program product of claim 34, wherein the historical payment amount is an average of a plurality of payment amounts within the geographic region for the type of work.

37. The computer program product of claim 34, wherein the historical payment amount is a median of a plurality of payment amount within the geographic region for the type of work.

38. The computer program product of claim 27, wherein the instructions further comprise:
initiating escalation for additional consideration of the invoice if the invoice is not approved.

39. The computer program product of claim 28, wherein the instructions for comparing comprise instructions for comparing retrieved historical billing data associated with a similar geographic region to the geographic region wherein the work is to be or has been performed with billing information extracted from the invoice.

40. A system for evaluating an invoice for work, the system comprising:
a processing device configured for:
determining one or more billing data parameters comprising a threshold payment amount based on information associated with the invoice or the work;
retrieving from a historical billing database, historical billing data corresponding to the one or more determined billing data parameters;
comparing the retrieved historical billing data including the threshold payment amount with at least a portion of the information extracted from the invoice including billing information extracted from the invoice; and
determining whether to approve the invoice based on the comparison, wherein determining whether to approve the invoice is dependent upon the comparison of the threshold payment amount with the requested payment amount corresponding to billing information extracted from the invoice.
